(19) United States
(12) Patent Application Publication
(10) Pub. No.: US 2010/0250961 A1
(43) Pub. Date: Sep. 30, 2010

(54) CONTROL DEVICE

(76) Inventors: Tsuyoshi Sato, Osaka (JP); Makoto Fujiwara, Kyoto (JP); Kenichiro Uda, Osaka (JP)

Correspondence Address: MCDERMOTT WILL & EMERY LLP, 600 13TH STREET, NW, WASHINGTON, DC, 20005-3096, US

(21) Appl. No.: 12/438,702

(22) PCT Filed: Aug. 17, 2007
(86) PCT No.: PCT/JP2007/066033

§ 371 Date: Feb. 24, 2009

(30) Foreign Application Priority Data
Aug. 29, 2006 (JP) 2006-231854

(51) Int. Cl. G06F 12/14

(52) U.S. Cl. 713/189

(57) ABSTRACT

A control device performs reading of data from a recording medium or writing of data into the recording medium. The control device includes a plurality of processing sections for performing at least any one of encrypting and decrypting processes, a plurality of interface sections serving as an interface to the recording medium respectively, and a controlling section for allocating one of the plurality of processing sections and one of the plurality of interface sections to each type of contents read from the recording medium or each type of contents written into the recording medium respectively. The control device encrypts or decrypts a plurality of contents in parallel.

### TECHNICAL FIELD

The present invention relates to a control device for processing a plurality of contents in parallel.

### BACKGROUND ART

On account of the digitization of the contents such as music, video, and the like and the progress of the distributing technology, the importance of technology concerning protection of a copyright is increasing. In particular, in case the contents of digital data are recorded in a recording medium, often the contents are encrypted and then recorded in the recording medium. As one of the encrypting technologies, there is the Cipher Block Chaining (CBC) system. In this CBC system, plaintext data is divided into a plurality of blocks, and the encryption and the decryption are carried out every block.

JP-A-11-161162 discloses the technology to encrypt and decrypt data rapidly by using the CBC system. In this technology, the encrypted data or the plaintext data is divided into a plurality of frames and a plurality of encrypting/decrypting sections are employed in parallel with a plurality of frames. Therefore, the encryption and the decryption of one data stream can be carried out rapidly.

Patent Literature 1: JP-A-11-161162

### DISCLOSURE OF THE INVENTION

### Problems that the Invention is to Solve

The technology disclosed in the above Publication can encrypt and decrypt one contents, but cannot encrypt and decrypt a plurality of contents in parallel. Therefore, for example, it is unfeasible to decrypt encrypted music contents and encrypted video contents in parallel, or it is unfeasible to encrypt the video contents while decrypting the encrypted music contents.

It is an object of the present invention to provide a control device capable of encrypting or decrypting a plurality of contents in parallel.

### Means for Solving the Problems

The present invention provides a control device for performing reading of data from a recording medium or writing of data into the recording medium, which includes a plurality of processing sections for performing at least one of encrypting and decrypting processes; a plurality of interface sections for interfacing with the recording medium respectively; and a controlling section for allocating one of the plurality of processing sections and one of the plurality of interface sections to each type of contents read from the recording medium or each type of contents written into the recording medium respectively.

The control device further includes a key information storing section for storing key data, obtained by performing authentication mutually with the recording medium, and an authentication type indicating a type of data, before the data is read from the recording medium or before the data is written into the recording medium. Information stored in the key information storing section is shared with the plurality of processing sections.

In the control device, the key information storing section stores the key data and the authentication type to correlate with each other.

In the control device, the key information storing section stores the key data and the authentication type to correlate with one of the plurality of processing sections, and the controlling section allocates the processing section, which is correlated with a same authentication type as the type of the contents, and the interface section corresponding to the processing section.

In the control device, the controlling section detects respective process states of the plurality of processing sections and states of the plurality of interface sections, and allocates the processing section and the interface section appropriately in response to detected results.

In the control device, any one of the plurality of interface sections reads the data from the recording medium or writes the data into the recording medium, and the controlling section controls the plurality of interface sections so that, while the allocated interface section is reading the data from the recording medium or writing the data into the recording medium, remaining interface sections do not access to the recording medium.

In the control device, the plurality of interface sections perform simultaneously the reading of the data from different recording mediums or the writing of the data into the different recording mediums respectively.

### ADVANTAGES OF THE INVENTION

According to the control device according to the present invention, a plurality of contents can be encrypted or decrypted in parallel.

### BRIEF DESCRIPTION OF THE DRAWINGS

FIG. 1 A block diagram showing a control device according to a first embodiment of the present invention.

FIG. 2 A block diagram showing information stored in a key information storing section.

### DESCRIPTION OF REFERENCE NUMERALS

101 control device
102 external IF section
103 controlling section
104 storing section
105 authentication processing section
106 key information storing section
107a to 107c encrypting/decrypting section
110a to 110c input/output IF section
113 recording medium

### BEST MODE FOR CARRYING OUT THE INVENTION

Embodiments of the present invention will be explained with reference to the drawings hereinafter. A control device of the embodiment explained hereunder reads the data, which is encrypted based on the standard for copyright protection such as CPRM (Content Protection for Recordable Media), or the like, from a recording medium or writes the data to the recording medium, while performing authentication mutually with a recording medium such as recordable DVD, memory card, or the like. As the data recorded in the recording medium, for example, there are multimedia contents such as music, video, and the like.

### First Embodiment

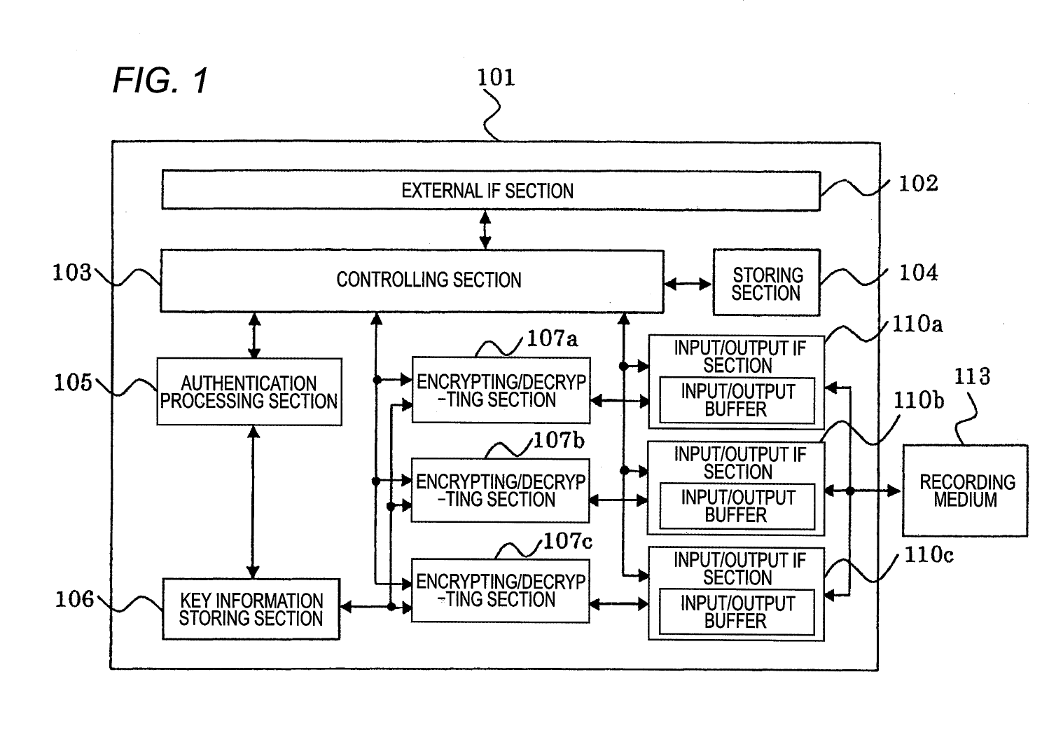

FIG. 1 is a block diagram showing a control device according to a first embodiment of the present invention. As shown in FIG. 1, a control device 101 of the present embodiment includes three input/output IF sections 110a to 110c, an authentication processing section 105, three encrypting/decrypting sections 107a to 107c, a controlling section 103, a key information storing section 106, an external IF section 102, and a storing section 104. Here, the input/output IF section 110a corresponds to the encrypting/decrypting section 107a, the input/output IF section 110b corresponds to the encrypting/decrypting section 107b, and the input/output IF section 110c corresponds to the encrypting/decrypting section 107c.

The input/output IF sections 110a to 110c are an interface to an external recording medium 113 such as a recordable DVD, a memory card, or the like respectively. The input/output IF sections 110a to 110c have a buffer for holding the data in the inside respectively. The authentication processing section 105 executes the mutual authentication with the recording medium 113, and either of the input/output IF sections 110a to 110c produces key data peculiar to the recording medium 113 by using information obtained from the recording medium 113. Key data that the authentication processing section 105 produces is different every recording medium that the control device 101 accesses, and is also different depending on the attribute of data read from the recording medium 113 or data (e.g., music data or video data) written into the recording medium 113. Since the data with a particular attribute is executed by a predetermined application, an event that the key data is different depending on the attribute of data is equal to an event that the key data is different in answer to the application.

The encrypting/decrypting sections 107a to 107c decrypts the data read from the recording medium 113 or encrypts the plaintext data, by using the key data that the authentication processing section 105 produces. The controlling section 103 stores the attribute of data as well as the key data that the authentication processing section 105 produces, as authentication type in the key information storing section 106. The information stored in the key information storing section 106 are shared with three encrypting/decrypting sections 107a to 107c. Details of the controlling section 103 will be described later.

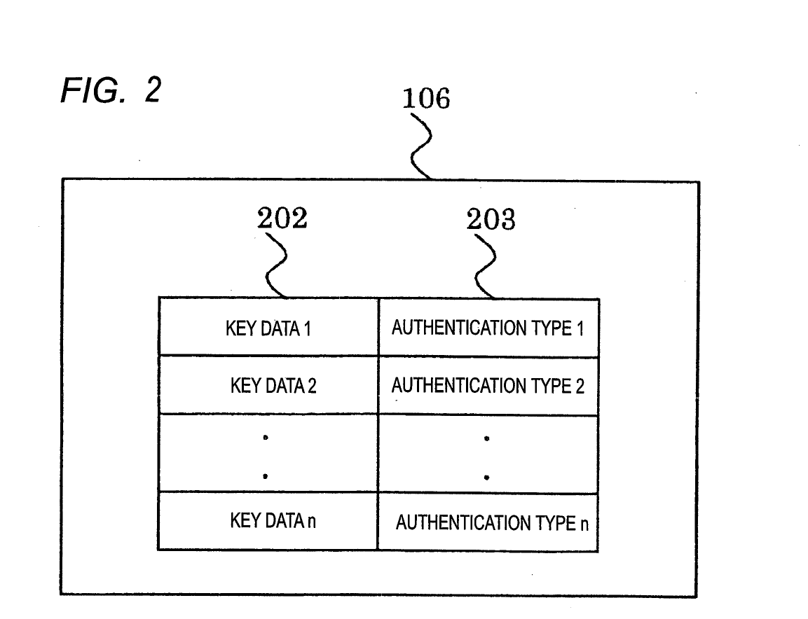

As shown in FIG. 2, the key information storing section 106 stores key data 202 that the authentication processing section 105 produces and data attribute (authentication type) 203 therein to correlate with each other. Here, any one of three encrypting/decrypting sections 107a to 107c may be correlated with each authentication type. In this case, a particular encrypting/decrypting section is employed in response to the type of contents. The external IF section 102 is an interface to the external equipment. The storing section 104 temporarily holds the data being input from the external IF section 102 before such data is sent to the encrypting/decrypting section 107 or temporarily holds the data being decrypted by the encrypting/decrypting section before such data is output from the external IF section 102.

Next, details of the controlling section 103 of the present embodiment will be explained hereunder. The controlling section 103 detects respective process states of the encrypting/decrypting sections 107a to 107c and respective states of buffers that the input/output IF sections 110a to 110c have respectively. The controlling section 103 controls the encrypting/decrypting sections 107a to 107c and the input/output IF sections 110a to 110c in response to the detected process states and the states of the buffers. In the present embodiment, one recording medium 113 is connected to three input/output IF sections 110a to 110c. Therefore, the controlling section 103 controls these input/output IF sections such that, while one input/output IF section is reading the data from the recording medium 113 or writing the data into the recording medium 113, remaining input/output IF sections do not have access to the recording medium 113. That is, in the present embodiment, exclusive control of the input/output IF sections about the access to the recording medium 113 is needed.

Also, the controlling section 103 allocates one of the encrypting/decrypting sections 107a to 107c and one of the input/output IF sections 110a to 110c every type of the contents read from the recording medium 113 or every type of the contents written into the recording medium 113 respectively. There are two types as the allocating method.

One is the method of allocating fixedly the encrypting/decrypting section and the input/output IF section in response to the authentication type. When this method is employed, any one of the encrypting/decrypting sections 107a to 107c must be correlated with each authentication type stored in the key information storing section 106. The controlling section 103 allocates the input/output IF section and the encrypting/decrypting section, which are utilized for the contents read from the recording medium 113 or the contents written into the recording medium 113, by referring to the information stored in the key information storing section 106. According to this allocating method, since the encrypting/decrypting section and the input/output IF section are always allocated every type of the contents, the control device 101 can execute the stable process.

The other is the method of allocating the appropriate encrypting/decrypting section and the appropriate input/output IF section, in response to respective process states of the encrypting/decrypting sections 107a to 107c and respective states of the buffers that the input/output IF sections 110a to 110c have. Here, the wording “respective process states of the encrypting/decrypting sections 107a to 107c” indicates whether or not the encrypting/decrypting section is now used, and the wording “respective states of the buffers that the input/output IF sections 110a to 110c have” indicates whether or not the concerned buffer is now used, i.e., not the concerned buffer is empty.

When the data is read from the recording medium 113, the controlling section 103 selects such a combination of the encrypting/decrypting section that is not used and the input/output IF section that has the empty buffer, from the encrypting/decrypting sections 107a to 107c and the input/output IF sections 110a to 110c, then reads the data of the contents in certain unit of numbers from the recording medium 113, then causes the input/output IF section to hold the data in the buffer, and then causes the encrypting/decrypting section to decrypt the data. For example, when the encrypting/decrypting section 107a is not used and the buffer of the input/output IF section 110a is empty, the controlling section 103 causes the input/output IF section 110a to hold once the data of the recording medium 113 in the buffer of the input/output IF section 110a, and then causes the encrypting/decrypting section 107a to decrypt the data. In this case, when there are plural sets of the encrypting/decrypting sections that are not used and the input/output IF sections having the empty buffer respectively, the controlling section 103 can choose arbitrarily any one from these combinations.

In contrast, similarly when the data is written into the recording medium 113, the controlling section 103 selects such a combination of the encrypting/decrypting section that is not used and the input/output IF section that has the empty buffer, from the encrypting/decrypting sections 107a to 107c and the input/output IF sections 110a to 110c, then causes the encrypting/decrypting section to decrypt the data, then causes the input/output IF section to store the encrypted data once in the buffer, and then writes the data into the recording medium 113. For example, when the encrypting/decrypting section 107a is not used and the buffer of the input/output IF section 110a is empty, the controlling section 103 causes the encrypting/decrypting section 107a to decrypt the data, then causes the input/output IF section 110a to store once the data in the buffer, and then writes the data into the recording medium 113.

According to this allocation method, the allocation can be done flexibly and effectively in response to respective states of the encrypting/decrypting sections 107a to 107c and the input/output IF sections 110a to 110c. Here, the reason why one encrypting/decrypting section and one input/output IF section can always be allocated to one contents in both allocation methods is that the Cipher Block Chain of the data encrypted by the CBC system, for example, is not interrupted.

An operation of the control device 101 of the present embodiment taken when this control device 101 reads the data from the recording medium 113 will be explained hereunder. The controlling section 103 controls the input/output IF section decided by the above-explained allocation method, and reads the data from the recording medium 113 and holds the data in the buffer of this input/output IF section unless remaining input/output IF sections have access to the recording medium 113. Then, the controlling section 103 controls the input/output IF section corresponding to this input/output IF section, and reads the data from the buffer, and causes the encrypting/decrypting section to decrypt the data. The controlling section 103 holds temporarily the decrypted data in the storing section 104, and then controls the external IF section 102 to output the data to the outside at an appropriate timing.

Next, an operation of the control device 101 of the present embodiment taken when this control device 101 writes the data into the recording medium 113 will be explained hereunder. The controlling section 103 stores temporarily plaintext data being input via the external IF section 102 in the storing section 104. Then, the controlling section 103 controls the encrypting/decrypting section decided by the allocating method explained above to encrypt the plaintext data. Then, the controlling section 103 sends the encrypted data to the input/output IF section corresponding to this encrypting/decrypting section, and hold temporarily the data in the buffer. Unless other input/output IF sections does not have access to the recording medium 113, the controlling section 103 controls this input/output IF section to write the data held in the buffer into the recording medium 113.

After applying the exclusive control of the input/output IF sections about the access to the recording medium 113, the control device 101 of the present embodiment can execute three operations of reading the data from the recording medium 113 or writing the data into the recording medium 113 at maximum in parallel. Also, the control device 101 can execute the reading operation and the writing operation in parallel.

### Second Embodiment

In the first embodiment, one recording medium is connected to three input/output IF sections 110a to 110c. A control device of a second embodiment has similarly three input/output IF sections 110a to 110c, but the recording medium is connected to the input/output IF sections respectively. Thus, three recording mediums are connected at maximum. Therefore, in the present embodiment, the exclusive control of the input/output IF sections about the access to the recording medium is not needed. As a result, the reading of the data from the recording medium and the writing of the data into the recording medium can be carried out rapidly.

The control device of the first and second embodiments explained above may be constructed either by the integrated circuit or the discrete components. Also, in the above embodiment, three encrypting/decrypting sections and three input/output IF sections are provided respectively. But the number of their combination is not limited to three, and four combinations or more may be employed.

The present invention is explained in detail with reference to particular embodiment. But it is obvious for those skilled in the art that various variations and modifications can be applied without departing from a spirit and a scope of the present invention.

This application is based upon Japanese Patent Application (Patent Application No. 2006-231854) filed on Aug. 29, 2006; the contents of which are incorporated herein by reference.

### INDUSTRIAL APPLICABILITY

The control device according to the present invention is useful as an electronic device that processes a plurality of contents in parallel, and the like.

1. A control device for performing reading of data from a recording medium or writing of data into the recording medium, comprising:
a plurality of processing sections which performs at least one of encrypting and decrypting processes;
a plurality of interface sections which interface with the recording medium respectively; and
a controlling section which allocates one of the plurality of processing sections and one of the plurality of interface sections to each type of contents read from the recording medium or each type of contents written into the recording medium respectively.

2. The control device according to claim 1, further comprising:
a key information storing section which stores key data, obtained by performing authentication mutually with the recording medium, and an authentication type indicating a type of data, before the data is read from the recording medium or before the data is written into the recording medium,
wherein information stored in the key information storing section is shared with the plurality of processing sections.

3. The control device according to claim 2, wherein the key information storing section stores the key data and the authentication type to correlate with each other.

4. The control device according to claim 3, wherein the key information storing section stores the key data and the authentication type to correlate with one of the plurality of processing sections; and
wherein the controlling section allocates the processing section, which is correlated with a same authentication type as the type of the contents, and the interface section corresponding to the processing section.

5. The control device according to claim 1, wherein the controlling section detects respective process states of the plurality of processing sections and states of the plurality of interface sections, and allocates the processing section and the interface section appropriately in response to detected results.

6. The control device according to claim 1, wherein any one of the plurality of interface sections reads the data from the recording medium or writes the data into the recording medium; and
wherein the controlling section controls the plurality of interface sections so that, while the allocated interface section is reading the data from the recording medium or writing the data into the recording medium, remaining interface sections do not access to the recording medium.

7. The control device according to claim 1, wherein the plurality of interface sections perform simultaneously the reading of the data from different recording mediums or the writing of the data into the different recording mediums respectively.
